(19) United States
(12) Patent Application Publication
(10) Pub. No.: US 2022/0307288 A1
(43) Pub. Date: Sep. 29, 2022

(54) COMBINATION DEADBOLT LOCK COVER

(71) Applicant: Johnny Lee Woods, JR., Turrell, AR (US)

(72) Inventor: Johnny Lee Woods, JR., Turrell, AR (US)

(21) Appl. No.: 17/214,330

(22) Filed: Mar. 26, 2021

(51) Int. Cl. E05B 17/18

(52) U.S. Cl. CPC E05B 17/186

(57) ABSTRACT

The COMBINATION DEADBOLT LOCK COVER is a cover that goes over the deadbolt to keep lock-pickers from gaining access to the deadbolt lock of a dwelling. It consists of two components. The first component is the cover that you place the outside locking mechanism of your deadbolt inside and secure it to the hole on your dwelling door that the deadbolt originally goes. Once you screw your deadbolt lock with the COMBINATION DEADBOLT LOCK COVER securely covering your deadbolt lock then you slide the second part of the COMBINATION DEADBOLT LOCK COVER which is a DROPDOWN PLATE into a prefabricated slot to render the deadbolt lock of your dwelling completely un-accessible. The DROPDOWN PLATE has a hole in it in which you can slide a combination lock or a standard lock into making the deadbolt lock on your dwelling door un-seen and un-accessible.

This product that I created on Mar. 19, 2021 is a COMBINATION DEADBOLT LOCK COVER. Its purpose is to keep a lock-picker from even gaining access to your deadbolt lock. It completely covers the deadbolt lock and with the drop-down locking plate mechanism you can put a combination lock or standard lock in it therefore completely rendering the cover a lock over the deadbolt lock. This function makes the security of your dwelling door twice as hard to get into. There are just two components to the COMBINATION DEADBOLT LOCK COVER. The first component to the COMBINATION DEADBOLT LOCK COVER is the MAIN FRAME(Body) which consists of the cover that is welded solid to a backing plate and goes over the deadbolt. The second component is the DROP-DOWN PLATE which slides down into two slots on the Main Frame. The DROP-DOWN PLATE has a hole punched into it in which you can slide a combination lock or standard lock into therefore cutting off complete access to your deadbolt. The COMBINATION DEADBOLT LOCK COVER has a 121 mm slot on the top and a 22 mm slot on the bottom in which the DROP-DOWN PLATE slides into. The slot is 3 mm wide to make the solid metal DROP-DOWN PLATE slide into it easily. It has a 44 mm inside diameter bottom plate with an outside diameter of 76 mm. (NOTE): All dimensions in all of the components of the COMBINATION DEADBOLT LOCK COVER can change by up to 20 mm lengthwise plus or minus and also up to 20 mm widthwise plus or minus

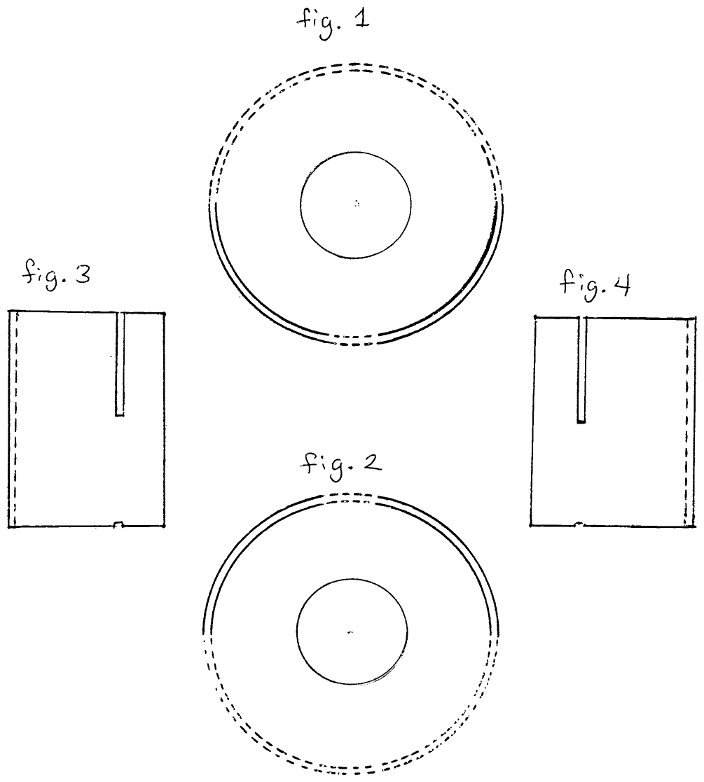

DETAILED DESCRIPTION (FIG. 1) OF REPLACEMENT DRAWING: Shows front view with 121 mm slot on top of cover with 22 mm slot on the bottom with 44 mm inside diameter hole on the bottom plate. (NOTE): All dimensions in all of the components of the COMBINATION DEADBOLT LOCK COVER can change by up to 20 mm lengthwise plus or minus and also 20 mm widthwise plus or minus

DETAILED DESCRIPTION (FIG. 2) OF REPLACEMENT DRAWING: Shows mirror image of FIG. 1 with 121 mm slot on the top of cover with 22 mm slot on the bottom with 44 mm inside diameter hole on the bottom plate. (NOTE): All dimensions in all of the components of the COMBINATION DEADBOLT LOCK COVER can change by up to 20 mm lengthwise plus or minus and also 20 mm widthwise plus or minus

DETAILED DESCRIPTION (FIG. 3) OF REPLACEMENT DRAWING: Shows left side view 3 mm slot cut out with 32 mm of metal in which the bottom plate is welded and 20 mm of metal in front of slot with 76 mm outside diameter on the body of the cover. (NOTE): All dimensions in all of the components of the COMBINATION DEADBOLT LOCK COVER can change by up to 20 mm lengthwise plus or minus and also 20 mm widthwise plus or minus

DETAILED DESCRIPTION (FIG. 4) OF REPLACEMENT DRAWING: Shows right side view (mirror image of FIG. 3) 3 mm slot cut out with 32 mm of metal in which the bottom plate is welded and 20 mm of metal in front of slot with 76 mm outside diameter on the body of the cover. (NOTE): All dimensions in all of the components of the COMBINATION DEADBOLT LOCK COVER can change by up to 20 mm lengthwise plus or minus and also 20 mm widthwise plus or minus

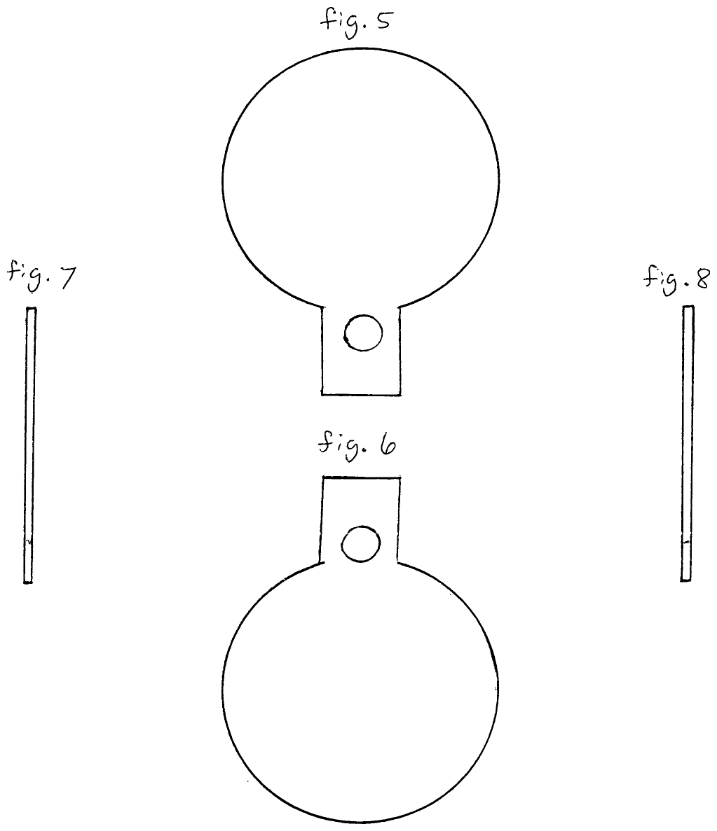

DETAILED DESCRIPTION (FIG. 5) OF REPLACEMENT DRAWING: Shows front view of DROPDOWN PLATE with 73.5 mm outside diameter and a 20 mm square protrusion which has a 7.5 mm hole punched into the protrusion. (NOTE): All dimensions in all of the components of the COMBINATION DEADBOLT LOCK COVER can change by up to 20 mm lengthwise plus or minus and also 20 mm widthwise plus or minus

DETAILED DESCRIPTION (FIG. 6) OF REPLACEMENT DRAWING: Shows rear view(mirror image of FIG. 5) which shows front view of the DROP-DOWN PLATE with a 73.5 mm outside diameter and a 20 mm square protrusion which has a 7.5 mm hole punched into the protrusion. (NOTE): All dimensions in all of the components of the COMBINATION DEADBOLT LOCK COVER can change by up to 20 mm lengthwise plus or minus and also 20 mm widthwise plus or minus

DETAILED DESCRIPTION (FIG. 7) OF REPLACEMENT DRAWING: Shows left side view of the DROP-DOWN PLATE. It is 91.5 mm in length and 1.95 mm in thickness. (NOTE): All dimensions in all of the components of the COMBINATION DEADBOLT LOCK COVER can change by up to 20 mm lengthwise plus or minus and also up to 20 mm widthwise plus or minus

DETAILED DESCRIPTION (FIG. 8) OF REPLACEMENT DRAWING: Shows right side view of the DROP-DOWN PLATE(mirror image of FIG. 7). It is 91.5 mm in length and 1.95 mm in width. (NOTE): All dimensions in all of the components of the COMBINATION DEADBOLT LOCK COVER can change by up to 20 mm lengthwise plus or minus and also up to 20 mm widthwise plus or minus

The COMBINATION DEADBOLT LOCK COVER is a cover that protects the deadbolt lock on a dwelling door. It consists of two components. The first component is the BODY which is constructed out of 14 gauge steel and rolled into a cylinder and welde4 solid to a BACKING PLATE. This completed cylindrical BODY allows you to insert a deadbolt Inside of it and bolt your deadbolt and the BODY to your dwelling door using the two bolts that already comes with your deadbolt kit. The COMBINATION DEADBOLT LOCK COVER has no bolts or screws. It affixes to your dwelling door via the deadbolt. The second component to the COMBINATION DEADBOLT LOCK COVER is the DROPDOWN PLATE which is constructed out of 14 gauge steel. The DROPDOWN PLATE slides down into two slots that are cut into the BODY. The DROPDOWN PLATE has a hole punched into it in which you can slide a standard lock or a combination lock into and lock it therefore making the COMBINATION DEADBOLT LOCK COVER one unit that is locked and secured.

1) The device is constructed from 14 gauge steel.

2) The BODY is rolled into a cylinder and welded solid to a backing plate.

3) The BODY has a slot at the top and a Slot at the bottom in which the DROPDOWN PLATE slides into.

4) The DROPDOWN PLATE is constructed from 14 gauge steel,

5) The DROPDOWN PLATE is a flat cylindrical plate with a 20 mm square flap that has a hole punched into it.

6) The flap on the DROPDOWN PLATE has a hole In which you can slide a standard lock or a combination lock into.

7) The COMBINATION DEADBOLT LOCK COVER has NO bolts or screws.
